(19) United States
(12) Patent Application Publication
(10) Pub. No.: US 2025/0391327 A1
(43) Pub. Date: Dec. 25, 2025

(54) DISPLAY DEVICE AND ELECTRONIC DEVICE

(71) Applicant: Samsung Display Co., Ltd., Yongin-si (KR)

(72) Inventors: Dong Hoon LEE, Yongin-si (KR); Min Jae JEONG, Yongin-si (KR); Bon Yong KOO, Yongin-si (KR)

(21) Appl. No.: 19/083,277

(22) Filed: Mar. 18, 2025

(30) Foreign Application Priority Data
Jun. 20, 2024 (KR) 10-2024-0080505
Jul. 26, 2024 (KR) 10-2024-0099597

(51) Int. Cl. G09G 3/32

(52) U.S. Cl. CPC G09G 3/32; G09G 2310/0267; G09G 2310/0291

(57) ABSTRACT

A display device includes: a substrate including a display area and a non-display area surrounding the display area; pixels in the display area and connected to first horizontal scan lines extending in a first direction and horizontal emission lines extending in the first direction; a first scan driver on one side of the non-display area; and a first emission driver on another side of the non-display area, wherein the first scan driver is connected to first vertical scan lines extending in a second direction different from the first direction, the first vertical scan lines contact the first horizontal scan lines in the display area, and the first emission driver is directly connected to the horizontal emission lines.

### CROSS-REFERENCE TO RELATED APPLICATION

The present application claims priority to and the benefit of Korean Patent Application No. 10-2024-0080505, filed on Jun. 20, 2024, and Korean Patent Application No. 10-2024-0099597, filed on Jul. 26, 2024, in the Korean Intellectual Property Office, the entire disclosures of each of which are incorporated herein by reference.

### BACKGROUND

### 1. Field

Aspects of some embodiments of the present disclosure relate to a display device and an electronic device.

### 2. Description of the Related Art

As information technology develops, importance of a display device, which is a connection medium between a user and information, has been highlighted. In response to this, a use of a display device such as a liquid crystal display device and an organic light emitting display device is increasing.

The display device may implement a narrow bezel that narrows a non-display area and widens a display area for functionality and aesthetic impression. At this time, circuits outside the display area may be concentrated on one side of the non-display area to minimize a width of other sides of the non-display area.

The above information disclosed in this Background section is only for enhancement of understanding of the background and therefore the information discussed in this Background section does not necessarily constitute prior art.

### SUMMARY

Aspects of some embodiments of the present disclosure include a display device and an electronic device capable of preventing or reducing a diagonal stain phenomenon while implementing a narrow bezel.

According to some embodiments of the present disclosure, a display device includes a substrate including a display area and a non-display area surrounding the display area, pixels positioned in the display area and connected to first horizontal scan lines extending in a first direction and horizontal emission lines extending in the first direction, a first scan driver positioned on one side of the non-display area, and a first emission driver positioned on another side of the non-display area, the first scan driver is connected to first vertical scan lines extending in a second direction different from the first direction, the first vertical scan lines contact the first horizontal scan lines in the display area, and the first emission driver is directly connected to the horizontal emission lines.

According to some embodiments, the substrate may further include a bending area between one side of the non-display area and the display area.

According to some embodiments, the first emission driver may be positioned in a direction opposite to the first direction from the display area, and the first scan driver may be positioned in a direction opposite to the second direction from the display area.

According to some embodiments, the display device may further include a second emission driver positioned in the first direction from the display area, and the second emission driver may be connected to at least a portion of the horizontal emission lines.

According to some embodiments, the first emission driver may include first emission stages, the second emission driver may include second emission stages, and the number of the first emission stages and the number of the second emission stages may be the same.

According to some embodiments, the number of the horizontal emission lines may be the same as the number of the first emission stages, one end of each of the horizontal emission lines may be connected to a corresponding one of the first emission stages, and another end of each of the horizontal emission lines may be connected to a corresponding one of the second emission stages.

According to some embodiments, the number of the horizontal emission lines may be greater than the number of the first emission stages, one end of the horizontal emission lines may be connected to a corresponding one of the first emission stages in a unit of two horizontal emission lines, and another end of the horizontal emission lines may be connected to a corresponding one of the second emission stages in a unit of two horizontal emission lines.

According to some embodiments, the horizontal emission lines may be alternately connected to one of the first emission stages or one of the second emission stages along the second direction.

According to some embodiments, each of the first emission stages may include a first logic circuit and a first buffer circuit, each of the second emission stages may include a second logic circuit and a second buffer circuit, the first buffer circuit may be positioned in a direction opposite to the second direction from the first logic circuit and is connected to a corresponding horizontal emission line, and the second buffer circuit may be positioned in the second direction from the second logic circuit and is connected to a corresponding horizontal emission line.

According to some embodiments, the horizontal emission lines may be alternately connected to one of the first emission stages or one of the second emission stages along the second direction in a unit of two horizontal emission lines.

According to some embodiments, each of the first emission stages may include a first logic circuit and a first buffer circuit, each of the second emission stages may include a second logic circuit and a second buffer circuit, the first buffer circuit may be positioned in a direction opposite to the second direction from the first logic circuit and may be connected to two corresponding horizontal emission lines, and the second buffer circuit may be positioned in the second direction from the second logic circuit and may be connected to two corresponding horizontal emission lines.

According to some embodiments, the display device may further include an additional scan driver positioned in the non-display area, and the additional scan driver may be connected to the first vertical scan lines.

According to some embodiments, the display device may further include a second scan driver positioned in the non-display area, the pixels may be further connected to second horizontal scan lines extending in the first direction, the second scan driver may be connected to second vertical scan lines extending in the second direction, and the second vertical scan lines may contact the second horizontal scan lines in the display area.

According to some embodiments, the display device may further include a third scan driver positioned in the non-display area, the pixels may be further connected to third horizontal scan lines extending in the first direction, the third scan driver may be connected to third vertical scan lines extending in the second direction, and the third vertical scan lines may contact the third horizontal scan lines in the display area.

According to some embodiments, the display device may further include a second scan driver positioned in the first direction from the display area, the pixels may be further connected to second horizontal scan lines extending in the first direction, and the second scan driver may be directly connected to the second horizontal scan lines.

According to some embodiments of the present disclosure, a display device includes a substrate including a display area, a first non-display area surrounding the display area, a bending area connected to the first non-display area, and a second non-display area connected to the bending area, pixels positioned in the display area and connected to first horizontal scan lines extending in a first direction and horizontal emission lines extending in the first direction, a first scan driver positioned in the second non-display area, and a first emission driver positioned in the first non-display area, the first scan driver is connected to first vertical scan lines extending in a second direction different from the first direction, the first vertical scan lines contact the first horizontal scan lines in the display area, and the first emission driver is directly connected to the horizontal emission lines.

According to some embodiments, the first vertical scan lines may sequentially cross the second non-display area, the bending area, the first non-display area, and the display area.

According to some embodiments, the first emission driver may be positioned in a direction opposite to the first direction from the display area, and the first scan driver may be positioned in a direction opposite to the second direction from the display area.

According to some embodiments, the display device may further include a second emission driver positioned in the first direction from the display area, and the second emission driver may be connected to at least a portion of the horizontal emission lines.

According to some embodiments, the first emission driver may include first emission stages, the second emission driver may include second emission stages, and the number of the first emission stages and the number of the second emission stages may be the same.

According to some embodiments of the present disclosure, an electronic device includes a processor to provide input image data; and a display device to display an image based on the input image data. The display device includes: a substrate including a display area and a non-display area surrounding the display area, pixels positioned in the display area and connected to first horizontal scan lines extending in a first direction and horizontal emission lines extending in the first direction, a first scan driver positioned on one side of the non-display area, and a first emission driver positioned on another side of the non-display area, the first scan driver is connected to first vertical scan lines extending in a second direction different from the first direction, the first vertical scan lines contact the first horizontal scan lines in the display area, and the first emission driver is directly connected to the horizontal emission lines.

According to some embodiments, the display device and an electronic device, the disclosure may prevent or reduce a diagonal stain phenomenon while implementing a narrow bezel.

### BRIEF DESCRIPTION OF THE DRAWINGS

The above and other characteristics of embodiments according to the present disclosure will become more apparent by describing in further detail aspects of some embodiments thereof with reference to the accompanying drawings, in which:

FIG. 1 is a diagram illustrating a display device according to some embodiments of the present disclosure;

FIG. 2 is a diagram illustrating a pixel according to some embodiments of the present disclosure;

FIGS. 3 and 4 are drawings illustrating a display frequency change according to some embodiments of the present disclosure;

FIG. 5 is a drawing illustrating an address scan period according to some embodiments of the present disclosure;

FIG. 6 is a drawing illustrating a self scan period according to some embodiments of the present disclosure;

FIG. 7 is a drawing illustrating a diagonal stain phenomenon;

FIG. 8 is a drawing illustrating a display device according to some embodiments of the present disclosure;

FIG. 9 is a drawing illustrating a first emission driver according to some embodiments of the present disclosure;

FIG. 10 is a drawing illustrating a first emission stage of the first emission driver of FIG. 9;

FIG. 11 is a drawing illustrating a method of driving the first emission stage of FIG. 10;

FIGS. 12 to 16 are drawings illustrating aspects of some configurations of a first emission driver and a second emission driver; and

FIGS. 17 to 19 are drawings illustrating a display device according to some embodiments of the present disclosure.

FIG. 20 is a block diagram of an electronic device according to an embodiment.

FIGS. 21 to 23 shows schematic views of various embodiments of an electronic device.

### DETAILED DESCRIPTION

Hereinafter, aspects of some embodiments of the present disclosure will be described in more detail with reference to the accompanying drawings so that those skilled in the art may easily carry out the disclosure. The disclosure may be implemented in various different forms and is not limited to the embodiments described herein.

In order to clearly describe the disclosure, parts that are not related to the description are omitted, and the same or similar elements are denoted by the same reference numerals throughout the specification. Therefore, the above-described reference numerals may be used in other drawings.

In addition, sizes and thicknesses of each component shown in the drawings are arbitrarily shown for convenience of description, and thus the disclosure is not necessarily limited to those shown in the drawings. In the drawings, thicknesses may be exaggerated to clearly express various layers and areas.

In addition, an expression “is the same” in the description may mean “is substantially the same”. That is, the expression “is the same” may be the same enough for those of ordinary skill to understand that it is the same. Other expressions may also be expressions in which “substantially” is omitted.

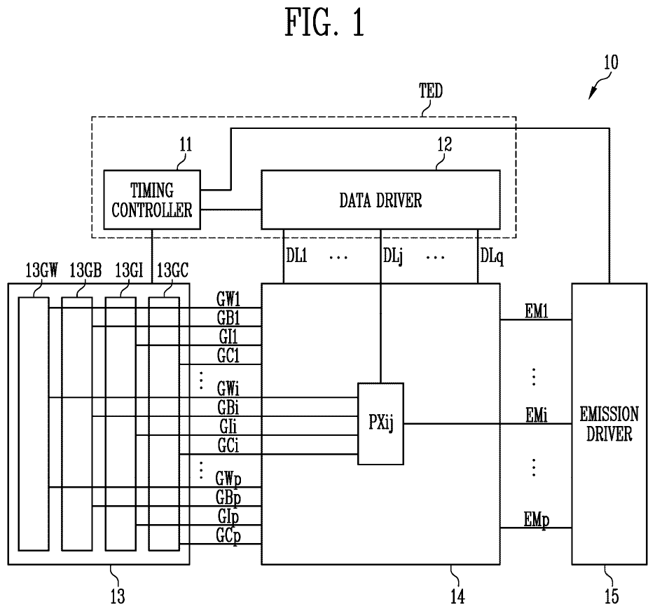

FIG. 1 is a diagram illustrating a display device according to some embodiments of the present disclosure.

Referring to FIG. 1, the display device 10 according to some embodiments of the present disclosure may include a timing controller 11, a data driver 12, a scan driver 13, a pixel unit 14, and an emission driver 15. According to various embodiments, the display device 10 may be incorporated into an electronic device, such as a television, computer monitor, laptop, tablet, smartphone, smart phone, wearable device, augmented reality device, virtual reality device, or a wearable device (e.g., a smart watch), although embodiments according to the present disclosure are not limited thereto, and the electronic device may include any suitable device in which a display device may be included or incorporated.

The timing controller 11 may receive grayscales for an input image (or an input frame). The grayscales may include a first color grayscale, a second color grayscale, and a third color grayscale. The first color grayscale may be a grayscale for expressing a first color, the second color grayscale may be a grayscale for expressing a second color, and the third color grayscale may be a grayscale for expressing a third color.

In addition, the timing controller 11 may receive a control signal for an image. Such a control signal may include a horizontal synchronization signal (Hsync), a vertical synchronization signal (Vsync), and a data enable signal. The vertical synchronization signal may include a plurality of pulses, and may indicate that a previous frame period is ended and a current frame period is started based on a time point at which each of the pulses is generated. An interval between adjacent pulses of the vertical synchronization signal may correspond to one frame period. The horizontal synchronization signal may include a plurality of pulses, and may indicate that a previous horizontal period is ended and a new horizontal period is started based on a time point at which each of the pulses is generated. An interval between adjacent pulses of the horizontal synchronization signal may correspond to one horizontal period. The data enable signal may have an enable level with respect to specific horizontal periods and a disable level in remaining periods. When the data enable signal is at the enable level, the data enable signal may indicate that color grayscales are supplied in corresponding horizontal periods.

The timing controller 11 may provide grayscales rendered or corrected to correspond to a specification of the display device 10 to the data driver 12. In addition, the timing controller 11 may provide a clock signal, a scan start signal, and the like to the scan driver 13. The timing controller 11 may provide a clock signal, an emission stop signal, and the like to the emission driver 15.

The data driver 12 may generate data voltages to be provided to data lines DL1, . . . , DLj, . . . , and DLq using the grayscales and control signals received from the timing controller 11. For example, the data driver 12 may sample the grayscales using the clock signal and apply the data voltages corresponding to the grayscales to the data lines in a pixel row unit. q may be an integer greater than 1, and j may be an integer greater than 0 and less than q.

According to some embodiments, the timing controller 11 and the data driver 12 may be implemented as one controller TED. Whether the timing controller 11 and the data driver 12 are configured as separate integrated circuits or configured as one integrated circuit may vary according to a product.

The scan driver 13 may include first to fourth scan drivers 13GW, 13GB, 13GI, and 13GC. The first scan driver 13GW may provide first scan signals to first scan lines GW1, . . . , GWi, . . . , and GWp. p may be an integer greater than 1, and i may be an integer greater than 0 and less than p. The second scan driver 13GB may provide second scan signals to second scan lines GB1, . . . , GBi, . . . , and GBp. The third scan driver 13GI may provide third scan signals to third scan lines GI1, . . . , Gli, . . . , and Glp. The fourth scan driver 13GC may provide fourth scan signals to fourth scan lines GC1, . . . , GCi, . . . , and GCp.

For example, the first scan driver 13GW may receive at least one scan clock signal and the scan start signal from the timing controller 11 to generate the first scan signals to be provided to the first scan lines GW1 to GWp. The first scan driver 13GW may sequentially provide first scan signals having a turn-on level of pulse to the first scan lines GW1 to GWp. For example, the first scan driver 13GW may be configured in a shift register form, and may generate the first scan signals in a method of sequentially transmitting a scan start signal which is a turn-on level of pulse form to a next scan stage under control of the scan clock signal.

Because each of the second scan driver 13GB, the third scan driver 13GI, and the fourth scan driver 13GC may be configured similarly to the first scan driver 13GW, an overlapping description is omitted. According to some embodiments, at least some of the first to fourth scan drivers 13GW, 13GB, 13GI, and 13GC may be integrated. For example, when a polarity and a width of a pulse are the same, two or more scan drivers may be integrated. For example, referring to FIG. 5 in advance, because a polarity and a width of a turn-on level of pulse applied to the third scan line Gli at a time point t2a and a turn-on level of pulse applied to fourth scan line GCi at a time point t3a are the same, the third scan driver 13GI and the fourth scan driver 13GC may be integrated and configured.

The emission driver 15 may receive at least one emission clock signal and the emission stop signal from the timing controller 11 and generate emission signals to be provided to emission lines EM1, . . . , EMi, . . . , and EMp. The emission driver 15 may sequentially provide emission signals having a turn-off level of pulse to the emission lines EM1 to EMp. For example, the emission driver 15 may be configured in a shift register form, and may generate the emission signals in a method of sequentially transmitting the emission stop signal which is a turn-off level of pulse form to a next emission stage according to control of an emission clock signal.

In FIG. 1, each of the first scan lines GW1 to GWp, the second scan lines GB1 to GBp, the third scan lines GI1 to Glp, the fourth scan lines GC1 to GCp, and the emission lines EM1 to EMp are shown as p. However, according to some embodiments, at least one of the second scan lines GB1 to GBp, the third scan lines GI1 to Glp, the fourth scan lines GC1 to GCp, or the emission lines EM1 to EMp may be configured as p/2 or less. For example, two adjacent pixel rows may share one second scan line. Similarly, two adjacent pixel rows may share one third scan line, fourth scan line, or emission line. The same pixel row means pixels connected to the same first scan line.

The pixel unit 14 includes pixels. Each pixel PXij may be connected to corresponding data line DLj, scan lines GWi, GBi, Gli, and GCi, and emission line EMi. Each pixel PXij may include a light emitting element that emits light based on a received data voltage.

The pixel unit 14 may include first pixels emitting light of the first color, second pixels emitting light of the second color, and third pixels emitting light of the third color. The first color, the second color, and the third color may be different colors. For example, the first color may be one of red, green, and blue, the second color may be one other than the first color among red, green, and blue, and the third color may be one other than the first color and the second color among red, green, and blue. In addition, magenta, cyan, and yellow may be used instead of red, green, and blue as the first to third colors.

The pixel unit 14 may be arranged in various shapes such as diamond PENTILE™, RGB-Stripe, S-stripe, Real RGB, and normal PENTILE™ arrangement or configuration.

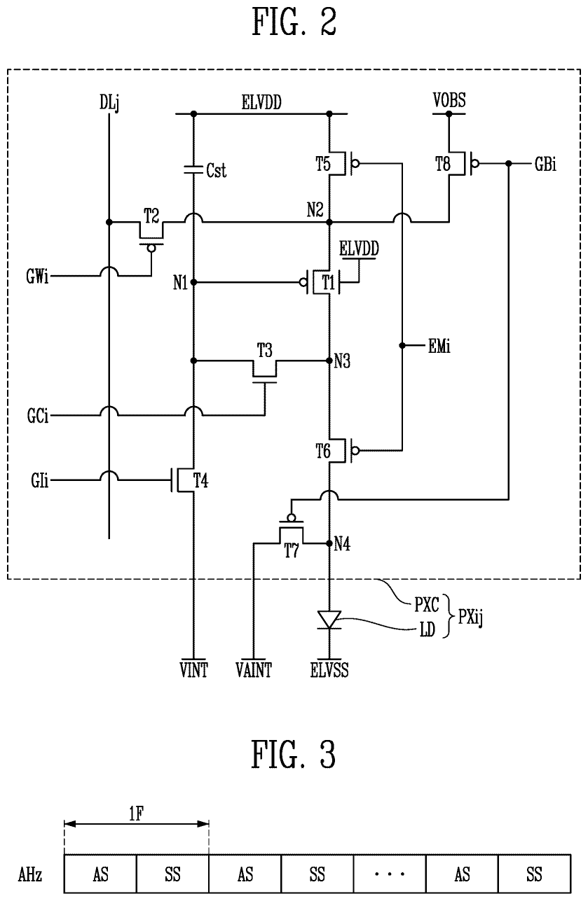

FIG. 2 is a diagram illustrating a pixel according to some embodiments of the present disclosure. Although FIG. 2 illustrates various components in a pixel according to some embodiments, embodiments according to the present disclosure are not limited thereto, and according to some embodiments, the pixel may include additional components or fewer components without departing from the spirit and scope of embodiments according to the present disclosure.

Referring to FIG. 2, the pixel PXij may include a pixel circuit PXC and a light emitting element LD. The pixel circuit PXC includes transistors T1, T2, T3, T4, T5, T6, T7, and T8 and a storage capacitor Cst.

The pixel PXij may be positioned in an i-th pixel row and may be positioned in a j-th pixel column. The pixel PXij may be the first pixel for expressing the first color. Because the second pixel for expressing the second color and the third pixel for expressing the third color may also be configured identically to the first pixel, an overlapping description is omitted.

P-type transistors may be polysilicon semiconductor transistors. In the polysilicon semiconductor transistor, a channel of an active layer may include a polysilicon semiconductor. For example, the poly silicon semiconductor transistor may be a low temperature poly-silicon (LTPS) thin film transistor. The polysilicon semiconductor transistor has high electron mobility and thus has a fast driving characteristic.

N-type transistors may be oxide semiconductor transistors. In the oxide semiconductor transistor, a channel of an active layer may include an oxide semiconductor. For example, the oxide transistor may be a low temperature polycrystalline oxide (LTPO) thin film transistor. The oxide semiconductor transistor has charge mobility lower than that of the polysilicon semiconductor transistor. Therefore, an amount of leakage current generated in a turn-off state of the oxide semiconductor transistor may be less than that of the polysilicon semiconductor transistors.

A gate electrode of the first transistor T1 may be connected to a first node N1, a first electrode may be connected to a second node N2, and a second electrode may be connected to a third node N3. The first transistor T1 may be a driving transistor. The first transistor T1 may be a P-type transistor. According to some embodiments, the first transistor T1 may further include a sub-gate electrode (a back gate electrode, or a body electrode), and the sub-gate electrode may receive a first power voltage ELVDD.

A gate electrode of the second transistor T2 may be connected to the first scan line GWi, a first electrode may be connected to the data line DLj, and a second electrode may be connected to the second node N2. The second transistor T2 may be a switching transistor. The second transistor T2 may be a P-type transistor.

The first scan driver 13GW may provide a turn-on level of first scan signal determining a time point when the pixel PXij receives the data voltage. For example, the second transistor T2 receiving the turn-on level of first scan signal may be turned on, and the second transistor T2 may apply the data voltage applied to the data line DLj to the second node N2.

A gate electrode of the third transistor T3 may be connected to the fourth scan line GCi, a first electrode may be connected to the first node N1, and a second electrode connected to the third node N3. The third transistor T3 may be a diode connection transistor. The third transistor T3 may be an N-type transistor.

A gate electrode of the fourth transistor T4 may be connected to the third scan line Gli, a first electrode may be connected to the first node N1, and a second electrode may receive a first initialization voltage VINT. The fourth transistor T4 may be a gate initialization transistor. The fourth transistor T4 may be an N-type transistor.

A gate electrode of the fifth transistor T5 may be connected to the emission line EMi, a first electrode may receive the first power voltage ELVDD, and a second electrode may be connected to the second node N2. The fifth transistor T5 may be a first emission control transistor. The fifth transistor T5 may be a P-type transistor.

A gate electrode of the sixth transistor T6 may be connected to the emission line EMi, a first electrode connected to the third node N3, and a second electrode connected to a fourth node N4. The sixth transistor T6 may be a second emission control transistor. The sixth transistor T6 may be a P-type transistor.

A gate electrode of the seventh transistor T7 may be connected to the second scan line GBi, a first electrode may receive a second initialization voltage VAINT, and a second electrode may be connected to the fourth node N4. The seventh transistor T7 may be an anode initialization transistor. The seventh transistor T7 may be a P-type transistor.

The second scan driver 13GB may provide a turn-on level of second scan signal determining a timing for initializing an anode voltage of the light emitting element LD. For example, the seventh transistor T7 receiving the turn-on level of second scan signal may be turned on, the second initialization voltage VAINT may be applied to an anode of the light emitting element LD, and thus the anode voltage of the light emitting element LD may be initialized to the second initialization voltage VAINT.

A gate electrode of the eighth transistor T8 may be connected to the second scan line GBi, a first electrode may receive a bias voltage VOBS, and a second electrode may be connected to the second node N2. The eighth transistor T8 may be a bias transistor. The eighth transistor T8 may be a P-type transistor.

A first electrode of the storage capacitor Cst may receive the first power voltage ELVDD, and a second electrode may be connected to the first node N1.

The anode of the light emitting element LD may be connected to the fourth node N4, and a cathode may receive a second power voltage ELVSS. The light emitting element LD may emit light in one of the first color, the second color, and the third color. The light emitting element LD may be a light emitting diode. The light emitting element LD may be configured of an organic light emitting diode, an inorganic light emitting diode, a quantum dot/well light emitting diode, or the like. According to some embodiments, each pixel is provided with only one light emitting element LD, but according to some embodiments, each pixel may be provided with a plurality of light emitting elements. At this time, the plurality of light emitting elements may be connected in series, parallel, series-parallel, or the like.

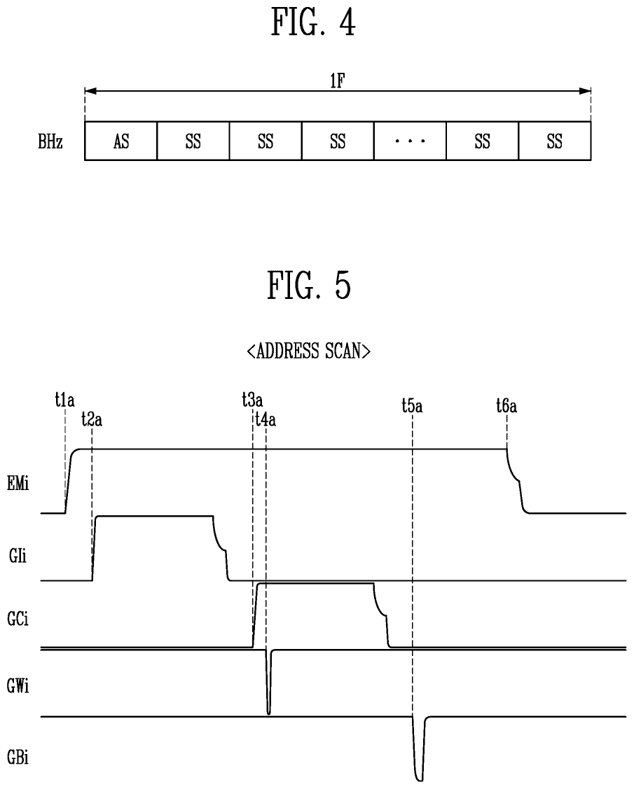

FIG. 3 and FIG. 4 are drawings illustrating a display frequency change according to some embodiments of the present disclosure.

The display device 10 may support a variable refresh rate (VRR). The refresh rate may be a frequency at which the data voltage is written to the pixel PXij, may be also referred to as a screen scan rate or a screen refresh rate, and may indicate the number of image frames played per second.

For example, the pixel unit 14 may display images at a first frequency AHz in a first mode (refer to FIG. 3), and may display images at a second frequency BHz lower than the first frequency AHz in a second mode (refer to FIG. 4).

For example, in the first mode, each frame period 1F may include one address scan period AS and one self scan period SS with respect to each pixel PXij. For example, in the second mode, each frame period 1F may include one address scan period AS and a plurality of self scan periods SS with respect to each pixel PXij. As the second frequency BHz decreases, the number of self scan periods SS included in one frame period 1F may increase. In another example, in a third mode, each frame period 1F may include only one address scan period AS and may not include the self scan period SS with respect to each pixel PXij.

The address scan period AS is a period for writing the data voltage to the pixel PXij. The address scan period AS may also be referred to as a data programming period for receiving the data voltage from the data line DLj.

The self scan period SS is a period in which the data voltage is not written to the pixel PXij. During an emission period of the self scan period SS, the pixel PXij may emit light using the data voltage written in the address scan period AS. A length of the self scan period SS may be equal to a length of the address scan period AS.

FIG. 5 is a drawing illustrating an address scan period according to some embodiments of the present disclosure. In describing FIG. 5, the pixel PXij of FIG. 2 is referred.

At a time point t1a, as an emission signal of a turn-off level (a high level) is applied to the emission line EMi, the fifth transistor T5 and the sixth transistor T6 are turned off, and thus the pixel PXij is in a non-emission state.

At a time point t2a, a third scan signal of a turn-on level (a high level) is applied to the third scan line Gli, and thus the fourth transistor T4 is turned on. Accordingly, the first initialization voltage VINT is applied to the first node N1. The first initialization voltage VINT may be a sufficiently low voltage and may on-bias the first transistor T1.

At a third time point t3a, a fourth scan signal of a turn-on level (a high level) is applied to the fourth scan line GCi, and thus the third transistor T3 is turned on. Therefore, the first transistor T1 is in a diode-connected state in which a drain electrode and the gate electrode are connected.

At a time point t4a, a first scan signal of a turn-on level (a low level) is applied to the first scan line GWi, and thus the second transistor T2 is turned on. Therefore, the data voltage of the data line DLj may be applied to the first node N1 through the second transistor T2, the first transistor T1, and the third transistor T3 that are in a turn-on state. At this time, a voltage of the first node N1 may be a compensation voltage obtained by subtracting a threshold voltage of the first transistor T1 from the data voltage. The storage capacitor Cst may maintain a difference between the first power voltage ELVDD and the compensation voltage.

At a time point t5a, a second scan signal of a turn-on level (a low level) is applied to the second scan line GBi, and thus the seventh transistor T7 and the eighth transistor T8 are turned on. As the seventh transistor T7 is turned on, the second initialization voltage VAINT may be applied to the anode of the light emitting element LD, and the light emitting element LD may be initialized to a charge amount corresponding to a voltage difference between the second initialization voltage VAINT and the second power voltage ELVSS. Accordingly, a low grayscale expression of the light emitting element LD may be facilitated.

In addition, as the eighth transistor T8 is turned on, a voltage of the second node N2 may be set to the bias voltage VOBS. Accordingly, because the bias voltage VOBS is applied to a source electrode of the first transistor T1, a hysteresis phenomenon may be prevented or reduced and an on-bias state may be guaranteed.

At a time point t6a, an emission signal of a turn-on level (a low level) is applied to the emission line EMi, and thus the fifth transistor T5 and the sixth transistor T6 may be turned on. Accordingly, a path of a driving current flowing from the first power voltage ELVDD to the second power voltage ELVSS via the fifth transistor T5, the first transistor T1, the sixth transistor T6, and the light emitting element LD is formed.

A driving current amount may be adjusted according to a voltage maintained in the storage capacitor Cst. The light emitting element LD emits light with a luminance corresponding to the driving current amount. The light emitting element LD may emit light until an emission signal of a turn-off level is applied to the emission line EMi.

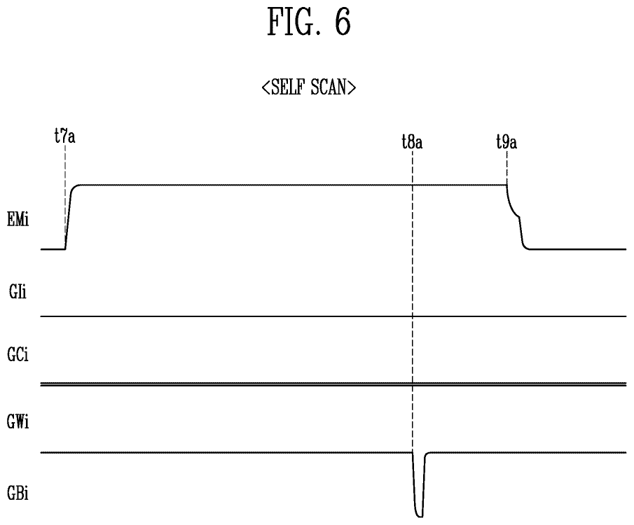

FIG. 6 is a drawing illustrating a self scan period according to some embodiments of the present disclosure. In describing FIG. 6, the pixel PXij of FIG. 2 is referred.

At a time point t7a, as an emission signal of a turn-off level (high level) is applied to the emission line EMi, the fifth transistor T5 and the sixth transistor T6 are turned off, and thus the pixel PXij is in the non-emission state.

During a period t7a to t8a, scan signals of a turn-off level is maintained in the first scan line GWi, the third scan line Gli, and the fourth scan line GCi. Therefore, the voltage of the first node N1 does not change.

At a time point t8a, a second scan signal of a turn-on level (low level) is applied to the second scan line GBi, the seventh transistor T7 and the eighth transistor T8 are turned on. As the seventh transistor T7 is turned on, the second initialization voltage VAINT may be applied to the anode of the light emitting element LD, and the light emitting element LD may be initialized with a charge amount corresponding to a voltage difference between the second initialization voltage VAINT and the second power voltage ELVSS. Accordingly, low grayscale expression of the light emitting element LD may be facilitated.

In addition, as the eighth transistor T8 is turned on, the voltage of the second node N2 may be set to the bias voltage VOBS. Accordingly, because the bias voltage VOBS is applied to the source electrode of the first transistor T1, the hysteresis phenomenon may be prevented or reduced and the on-bias state may be guaranteed.

At a time point t9a, an emission signal of a turn-on level (low level) is applied to the emission line EMi, and thus the fifth transistor T5 and the sixth transistor T6 may be turned on. Therefore, a path of a driving current flowing from the first power voltage ELVDD to the second power voltage ELVSS through the fifth transistor T5, the first transistor T1, the sixth transistor T6, and the light emitting element LD is formed.

The driving current amount may be controlled according to the voltage maintained in the storage capacitor Cst. Because the voltage of the first node N1 recorded during the address scan period AS is maintained during the self scan period SS, a luminance of the pixel PXij in the self scan period SS is the same as the luminance of the pixel PXij in the address scan period AS.

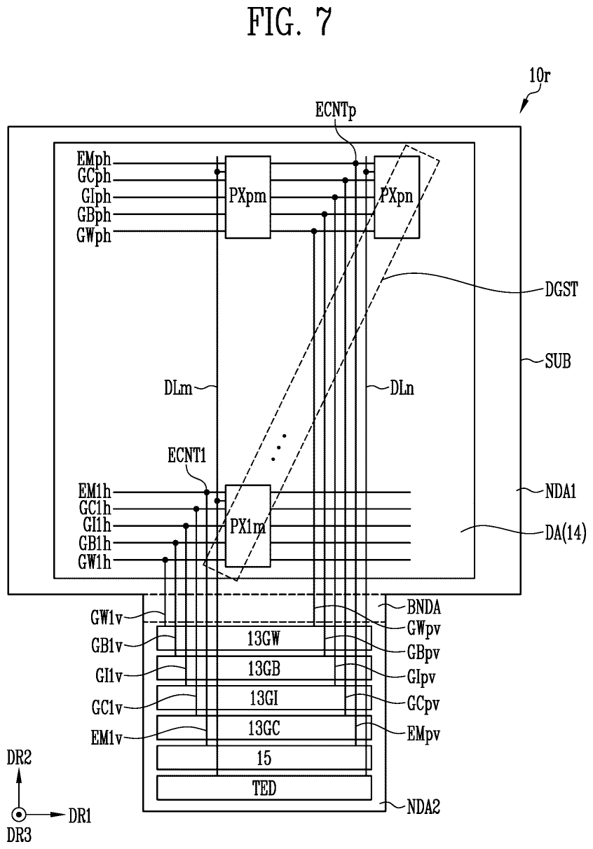

FIG. 7 is a drawing illustrating a diagonal stain phenomenon.

Referring to FIG. 7, a display device 10r may include a substrate SUB, pixels PX1m, PXpm, PXpn, . . . , a first scan driver 13GW, a second scan driver 13GB, a third scan driver 13GI, a fourth scan driver 13GC, an emission driver 15, and a controller TED.

The substrate SUB may include a display area DA and non-display areas NDA1, BNDA, and NDA2 surrounding the display area DA. The substrate SUB may include a bending area BNDA between one side of the non-display areas NDA1, BNDA, and NDA2 and the display area DA. For example, the substrate SUB may include a first non-display area NDA1 surrounding the display area DA, the bending area BNDA connected to the first non-display area NDA1, and a second non-display area NDA2 connected to the bending area BNDA.

A pixel unit 14 may be positioned in the display area DA. The pixel unit 14 may include a plurality of pixels PX1m, PXpm, PXpn, . . . . Each of the pixels PX1m, PXpm, PXpn, . . . may be connected to corresponding scan lines, emission line, and data line. For example, the pixel PX1m may be connected to a first horizontal scan line GW1h, a second horizontal scan line GB1h, a third horizontal scan line GI1h, a fourth horizontal scan line GC1h, and a horizontal emission line EM1h extending in a first direction DR1. In addition, the pixel PX1m may be connected to a data line DLm extending in a second direction DR2 from the controller TED. The second direction DR2 may be a direction different from the first direction DR1. For example, the second direction DR2 may be a direction perpendicular to the first direction DR1.

Hereinafter, for convenience, the first direction DR1 is defined as a horizontal direction, and the second direction DR2 is defined as a vertical direction. However, the first direction DR1 and the second direction DR2 may be directions for defining a plane, and the first direction DR1 and the second direction DR2 may have the same meaning even though the first direction DR1 is defined as the vertical direction and the second direction DR2 is defined as the horizontal direction.

Meanwhile, the pixel PXpn may be connected to a first horizontal scan line GWph, a second horizontal scan line GBph, a third horizontal scan line GIph, a fourth horizontal scan line GCph, and a horizontal emission line EMph extending in the first direction DR1. In addition, the pixel PXpn may be connected to a data line DLn extending in the second direction DR2 from the controller TED.

According to some embodiments, the scan drivers 13GW, 13GB, 13GI, and 13GC, the emission driver 15, and the controller TED may be located in the second non-display area NDA2. The first scan driver 13GW may be connected to first vertical scan lines GW1v, . . . , and GWpv extending in the second direction DR2, and the first vertical scan lines GW1v, . . . , and GWpv may contact first horizontal scan lines GW1h, . . . , and GWph in the display area DA. The second scan driver 13GB may be connected to second vertical scan lines GB1v, . . . , and GBpv extending in the second direction DR2, and the second vertical scan lines GB1v, . . . , and GBpv may contact second horizontal scan lines GB1h, . . . , and GBph in the display area DA. The third scan driver 13GI may be connected to third vertical scan lines GI1v, . . . , and GIpv extending in the second direction DR2, and the third vertical scan lines GI1v, . . . , and GIpv may contact third horizontal scan lines GI1h, . . . , and GIph in the display area DA. The fourth scan driver 13GC may be connected to fourth vertical scan lines GC1v, . . . , and GCpv extending in the second direction DR2, and the fourth vertical scan lines GC1v, . . . , and GCpv may contact fourth horizontal scan lines GC1h, . . . , and GCph in the display area DA.

The emission driver 15 may be connected to vertical emission lines EM1v, . . . , and EMpv extending in the second direction DR2, and the vertical emission lines EM1v, . . . , and EMpv may contact horizontal emission lines EM1h, . . . , EMph in the display area DA. For example, the vertical emission line EM1v may contact the horizontal emission line EM1h at a contact point ENCT1, and the vertical emission line EMpv may contact the horizontal emission line EMph at a contact point ENCTp.

According to some embodiments, because the scan drivers 13GW, 13GB, 13GI, and 13GC, the emission driver 15, and the controller TED are not located in the first non-display area NDA1, a narrow bezel may be implemented. Because the second non-display area NDA2 is positioned on a rear surface of the substrate SUB by folding of the bending area BNDA, the second non-display area NDA2 may not form a bezel.

However, even though the present embodiment is implemented, the first non-display area NDA1 is required to have a minimum width. This is because the pixels PX1m, PXpm, PXpn, . . . of the display area DA may include organic materials for light emission, and a minimum margin is required to prevent or reduce damage to the organic materials.

In addition, an undesirable diagonal stain DGST may be displayed near contact points ENCT1, . . . , and ECNTp of the vertical emission lines EM1v, . . . , and EMpv and the horizontal emission lines EM1h, . . . , and EMph. The diagonal stain DGST may occur due to voltage coupling caused by a voltage level fluctuation of emission signals. A voltage level fluctuation of scan signals may also affect the diagonal stain DGST, but a voltage level fluctuation of emission signals of which a width of a pulse is long may be the most important cause of the diagonal stain DGST.

For example, a voltage level of a data voltage applied to an adjacent data line DLm may fluctuate according to a voltage level fluctuation of an emission signal applied to the vertical emission line EM1v. At this time, when a first scan signal of a turn-on level is applied to the first scan line GW1v and GW1h, a data voltage of which a voltage level is fluctuated may be written to the pixel PX1m. Similarly, when data voltages of which a voltage level is fluctuated are written to the pixels PX1m, . . . , and PXpn, the diagonal stain DGST may be displayed.

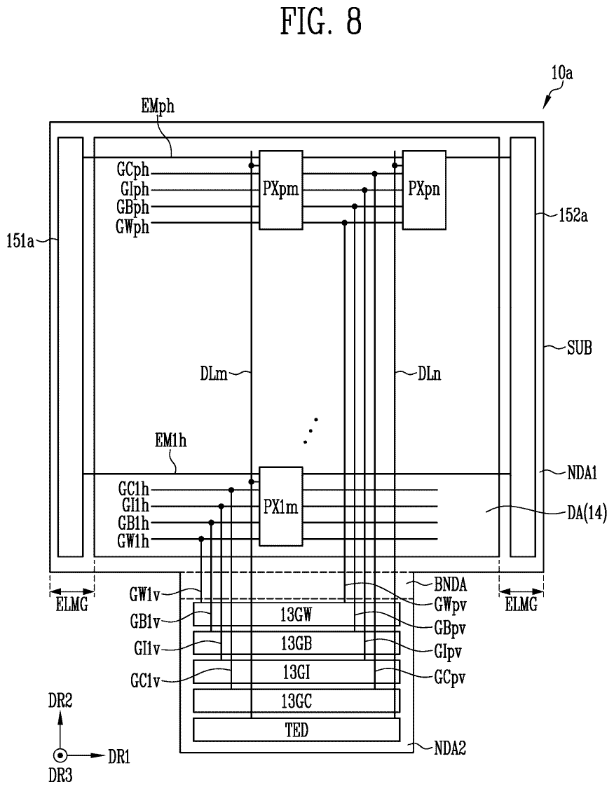

FIG. 8 is a drawing illustrating a display device according to some embodiments of the present disclosure.

Referring to FIG. 8, a display device 10a may include a substrate SUB, pixels PX1m, PXpm, PXpn, . . . , a first scan driver 13GW, a second scan driver 13GB, a third scan driver 13GI, a fourth scan driver 13GC, a first emission driver 151a, a second emission driver 152a, and a controller TED.

The substrate SUB may include a display area DA and non-display areas NDA1, BNDA, and NDA2 surrounding the display area DA. The substrate SUB may include a bending area BNDA between one side of the non-display areas NDA1, BNDA, and NDA2 and the display area DA. For example, the substrate SUB may include a first non-display area NDA1 surrounding the display area DA, the bending area BNDA connected to the first non-display area NDA1, and a second non-display area NDA2 connected to the bending area BNDA.

A pixel unit 14 may be positioned in the display area DA. The pixel unit 14 may include a plurality of pixels PX1m, PXpm, PXpn, . . . . Each of the pixels PX1m, PXpm, PXpn, . . . may be connected to corresponding scan lines, emission line, and data line. For example, the pixel PX1m may be connected to a first horizontal scan line GW1h, a second horizontal scan line GB1h, a third horizontal scan line GI1h, a fourth horizontal scan line GC1h, and a horizontal emission line EM1h extending in a first direction DR1. In addition, the pixel PX1m may be connected to a data line DLm extending in a second direction DR2 from the controller TED. The second direction DR2 may be a direction different from the first direction DR1. For example, the second direction DR2 may be a direction perpendicular to the first direction DR1.

Hereinafter, for convenience, the first direction DR1 is defined as a horizontal direction, and the second direction DR2 is defined as a vertical direction. However, the first direction DR1 and the second direction DR2 may be directions for defining a plane, and the first direction DR1 and the second direction DR2 may define the same plane even though the first direction DR1 is defined as the vertical direction and the second direction DR2 is defined as the horizontal direction.

Meanwhile, the pixel PXpn may be connected to a first horizontal scan line GWph, a second horizontal scan line GBph, a third horizontal scan line GIph, a fourth horizontal scan line GCph, and a horizontal emission line EMph extending in the first direction DR1. In addition, the pixel PXpn may be connected to a data line DLn extending in the second direction DR2 from the controller TED.

The scan drivers 13GW, 13GB, 13GI, and 13GC and the controller TED may be located in the second non-display area NDA2. The first scan driver 13GW may be connected to first vertical scan lines GW1v, . . . , and GWpv extending in the second direction DR2, and the first vertical scan lines GW1v, . . . , and GWpv may contact first horizontal scan lines GW1h, . . . , and GWph in the display area DA. The second scan driver 13GB may be connected to second vertical scan lines GB1v, . . . , and GBpv extending in the second direction DR2, and the second vertical scan lines GB1v, . . . , and GBpv may contact second horizontal scan lines GB1h, . . . , and GBph in the display area DA. The third scan driver 13GI may be connected to third vertical scan lines GI1v, . . . , and GIpv extending in the second direction DR2, and the third vertical scan lines GI1v, . . . , and GIpv may contact third horizontal scan lines GI1h, . . . , and GIph in the display area DA. The fourth scan driver 13GC may be connected to fourth vertical scan lines GC1v, . . . , and GCpv extending in the second direction DR2, and the fourth vertical scan lines GC1v, . . . , and GCpv may contact fourth horizontal scan lines GC1h, . . . , and GCph in the display area DA.

According to some embodiments, when the first scanning driver 13GW is positioned on one side of the non-display areas NDA1, BNDA, and NDA2, the first emission driver 151a may be positioned on another side of the non-display areas NDA1, BNDA, and NDA2. Here, the one side may indicate an edge positioned in a direction opposite to the second direction DR2 with respect to the display area DA, and the other side may indicate an edge positioned in a direction opposite to the first direction DR1 with respect to the display area DA.

The first emission driver 151a may be positioned in the first non-display area NDA1. The first emission driver 151a may be directly connected to the horizontal emission lines EM1h, . . . , and EMph. That is, the first emission driver 151a may be directly connected to the horizontal emission lines EM1h, . . . , and EMph without passing through vertical emission lines. Therefore, the contact points ENCT1, . . . , and ECNTp shown in FIG. 7 do not exist. According to some embodiments, because voltage coupling of emission signals and data voltages is minimized, occurrence of the diagonal stain DGST such as in a case of FIG. 7 may be prevented or reduced.

In addition, as described above with reference to FIG. 7, the first non-display area NDA1 is required to have a minimum width. This is because the pixels PX1m, PXpm, PXpn, . . . of the display area DA may include organic materials for emission, and a minimum margin ELMG is required to prevent or reduce damage to the organic materials. This margin ELMG may be approximately 300 micrometers. A width of the first direction DR1 of the first emission driver 151a may be configured to be approximately 268 micrometers. Therefore, even though the first emission driver 151a is positioned in the first non-display area NDA1 as in FIG. 8, a bezel width of the display device 10a of FIG. 8 may be maintained identically to a bezel width of the display device 10r of FIG. 7. Therefore, implementation of a narrow bezel is still possible.

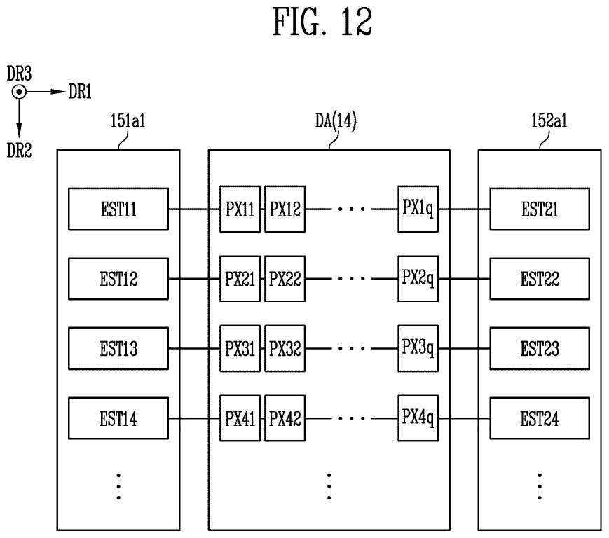

According to some embodiments, the second emission driver 152a may be positioned in the first non-display area NDA1. The second emission driver 152a may be positioned in the first direction DR1 from the display area DA. The second emission driver 152a may be connected to at least a portion of the horizontal emission lines EM1h, . . . , and EMph. The second emission driver 152a may be directly connected to at least a portion of the horizontal emission lines EM1h, . . . , and EMph without passing through vertical emission lines. Examples of connection of the second emission driver 152a and the horizontal emission lines EM1h, . . . , and EMph are described later with reference to FIGS. 12 to 16.

A width of the first direction DR1 of the second emission driver 152a may be the same (or substantially the same) as the width of the first direction DR1 of the first emission driver 151a. Therefore, the width of the second emission driver 152a may be equal to or less than the margin ELMG of the first non-display area NDA1, and the display device 10a may still implement a narrow bezel.

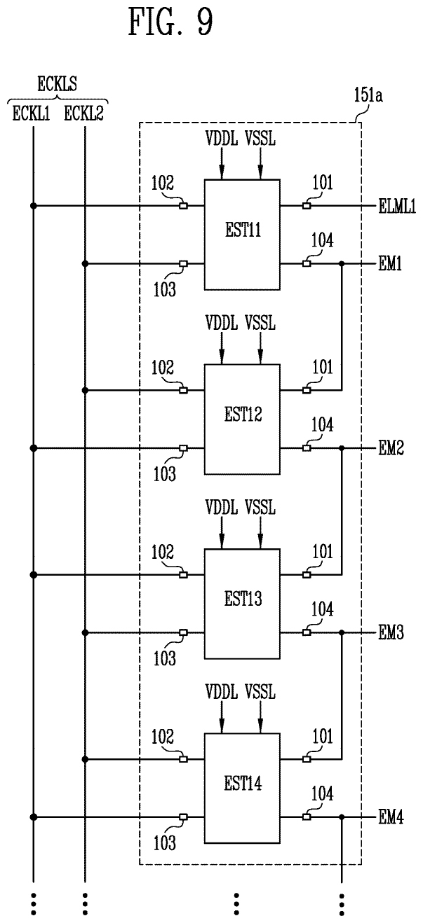

FIG. 9 is a drawing illustrating a first emission driver according to some embodiments of the present disclosure.

Referring to FIG. 9, the first emission driver 151a may include a plurality of first emission stages EST11 to EST14. For convenience of description, FIG. 9 shows four first emission stages EST11 to EST14. The first emission stages EST11 to EST14 may be connected to corresponding emission lines EM1 to EM4, respectively, and may be commonly connected to emission clock lines ECKLS. The first emission stages EST11 to EST14 may have the same (or substantially the same) circuit structure.

Each of the first emission stages EST11 to EST14 may include a first input terminal 101, a second input terminal 102, a third input terminal 103, and an output terminal 104.

The first input terminal 101 may receive an output signal (an emission signal or a carry signal) of a previous emission stage or a first emission stop signal. For example, the first input terminal 101 of a first first emission stage EST11 may be connected to a first emission stop line ELML1, and the first input terminal 101 of remaining first emission stages EST12 to EST14 may be connected to an emission line of the previous emission stage.

The second input terminal 102 of an I-th (I is an odd number or an even number) emission stage may be connected to a clock line ECKL1, and the third input terminal 103 may be connected to a clock line ECKL2. In addition, the second input terminal 102 of an (I+1)-th emission stage may be connected to the clock line ECKL2, and the third input terminal 103 may be connected to the clock line ECKL1. That is, the clock line ECKL1 and the clock line ECKL2 may be alternately connected to the second input terminal 102 and the third input terminal 103 of each emission stage.

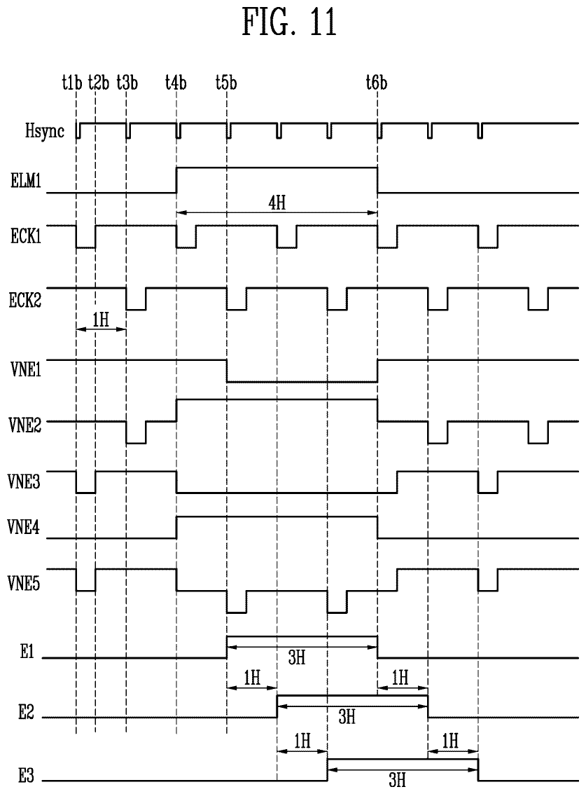

Pulses of a clock signal ECK1 applied to the clock line ECKL1 and pulses of a clock signal ECK2 applied to the clock line ECKL2 do not overlap each other in time (refer to FIG. 11). At this time, each of the pulses may be a turn-on level.

The first emission stages EST11 to EST14 may be connected to a power line VDDL and a power line VSSL. A voltage of the power line VDDL may be set to a turn-off level, and a voltage of the power line VSSL may be set to a turn-on level. A voltage level of the emission signal may be set based on the voltage of one of the power line VDDL and the power line VSSL.

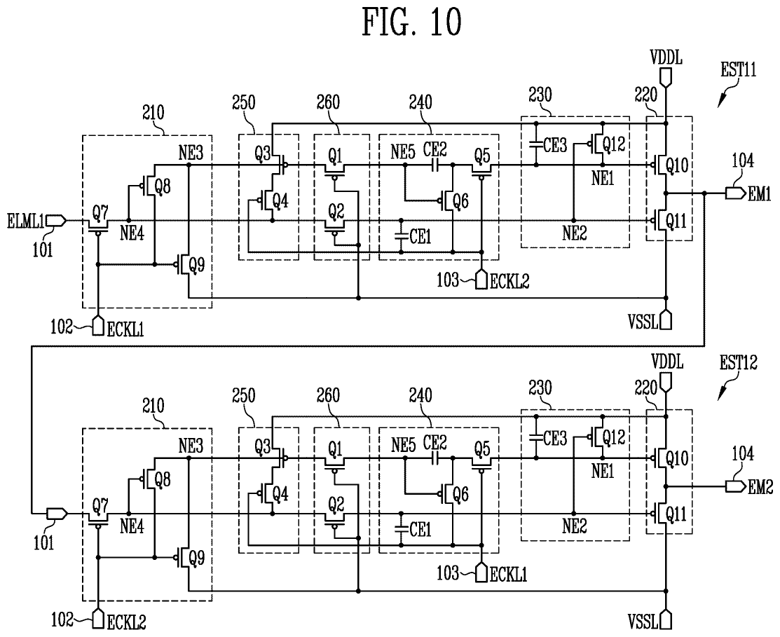

FIG. 10 is a drawing illustrating the first emission stage of the first emission driver of FIG. 9.

Referring to FIG. 10, the first emission stage EST11 may include an input unit 210, an output unit 220, a first signal processing unit 230, a second signal processing unit 240, a third signal processing unit 250, and a first stabilization unit 260. The output unit 220 may supply the voltage of the power line VDDL or the power line VSSL to the output terminal 104 in response to a voltage of a node NE1 and a node NE2. To this end, the output unit 220 may include a transistor Q10 and a transistor Q11. Each of the transistors Q10, Q11 may be referred to as a buffer transistor, and the output unit 220 may be referred to as a buffer circuit. The transistors Q10 and Q11 may have the area greater than the area of other transistors for smooth current flow. The other circuit unit 210, 230, 240, 250, and 260 except for the output unit 220 may be referred to as logic circuits.

The transistor Q10 may be connected between the power line VDDL and the output terminal 104. In addition, a gate electrode of transistor Q10 may be connected to the node NE1. The transistor Q10 may be turned on or off in response to the voltage of the node NE1. Here, when transistor Q10 is turned on, the voltage of the power line VDDL supplied to the output terminal 104 may be output as an emission signal of a turn-off level through the emission line EM1.

The transistor Q11 may be connected between the output terminal 104 and the power line VSSL. In addition, a gate electrode of the transistor Q11 may be connected to the node NE2. The transistor Q11 may be turned on or off in response to the voltage of the node NE2. Here, when the transistor Q11 is turned on, the voltage of the power line VSSL supplied to the output terminal 104 may be output as an emission signal of a turn-on level through the emission line EM1.

The input unit 210 may control a voltage of a node NE3 and a node NE4 in response to a signal supplied to the first input terminal 101 and the second input terminal 102. To this end, the input unit 210 may include a transistor Q7, a transistor Q8, and a transistor Q9.

The transistor Q7 may be connected between the first input terminal 101 and the node NE4. In addition, a gate electrode of the transistor Q7 may be connected to the second input terminal 102. Such a transistor Q7 may be turned on when a clock signal of a turn-on level is supplied to the second input terminal 102 to electrically connect the first input terminal 101 and the node NE4.

The transistor Q8 may be connected between the node NE3 and the second input terminal 102. In addition, a gate electrode of the transistor Q8 may be connected to the node NE4. Such a transistor Q8 may be turned on or off in response to a voltage of the node NE4.

The transistor Q9 may be connected between the node NE3 and the power line VSSL. In addition, a gate electrode of the transistor Q9 may be connected to the second input terminal 102. Such a transistor Q9 may be turned on when a clock signal of a turn-on level is supplied to the second input terminal 102, to supply the voltage of the power line VSSL to the node NE3.

The first signal processing unit 230 may control the voltage of the node NE1 in response to the voltage of the node NE2. To this end, the first signal processing unit 230 may include a transistor Q12 and a capacitor CE3.

The transistor Q12 may be connected between the power line VDDL and the node NE1. In addition, a gate electrode of the transistor Q12 may be connected to the node NE2. The transistor Q12 may be turned on or off in response to the voltage of the node NE2.

The capacitor CE3 may be connected between the power line VDDL and the node NE1. The capacitor CE3 may maintain a voltage applied to the node NE1.

The second signal processing unit 240 may be connected to a node NE5 and may control the voltage of the node NE1 in response to a signal supplied to the third input terminal. To this end, the second signal processing unit 240 may include a transistor Q5, a transistor Q6, a capacitor CE1, and a capacitor CE2.

The capacitor CE1 may be connected between the node NE2 and the third input terminal 103. The capacitor CE1 may maintain a voltage difference between the third input terminal 103 and the node NE2.

A first electrode of the capacitor CE2 may be connected to the node NE5, and a second electrode may be connected to the transistor Q5.

The transistor Q5 may be connected between the second electrode of the capacitor CE2 and the node NE1. In addition, a gate electrode of the transistor Q5 may be connected to the third input terminal 103. The transistor Q5 may be turned on when a clock signal is supplied to the third input terminal 103 to electrically connect the second electrode of the capacitor CE2 and the node NE1.

The transistor Q6 may be connected between the second electrode of the capacitor CE2 and the third input terminal 103. In addition, a gate electrode of the transistor Q6 may be connected to the node NE5.

The third signal processing unit 250 may control the voltage of the node NE4 in response to a voltage of the node NE3 and a signal supplied to the third input terminal 103. To this end, the third signal processing unit 250 may include a transistor Q3 and a transistor Q4.

The transistor Q3 and the transistor Q4 may be connected in series between the power line VDDL and the node NE4. A gate electrode of the transistor Q3 may be connected to the node NE3. In addition, a gate electrode of the transistor Q4 may be connected to the third input terminal 103.

The first stabilization unit 260 may be connected between the second signal processing unit 240 and the input unit 210. The first stabilization unit 260 may limit a voltage drop width of the node NE3 and the node NE4. The first stabilization unit 260 may include a transistor Q1 and a transistor Q2.

The transistor Q1 may be connected between the node NE3 and the node NE5. In addition, a gate electrode of the transistor Q1 may be connected to the power line VSSL. The transistor Q2 may be connected between the node NE2 and the node NE4. In addition, a gate electrode of the transistor Q2 may be connected to the power line VSSL.

Meanwhile, a configuration of the second first emission stage EST12 may be the same (or substantially the same) as the first first emission stage EST11 except for a signal supplied to the first input terminal 101, the second input terminal 102, and the third input terminal 103. Therefore, an overlapping description of the first emission stage EST12 is omitted.

FIG. 11 is a drawing illustrating a method of driving the first emission stage of FIG. 10.

In FIG. 11, an operation process is described based on the first first emission stage EST11.

Referring to FIG. 11, each of the pulses of the clock signal ECK1 and the pulses of the clock signal ECK2 is shown as having a cycle of two horizontal periods and generating in different horizontal periods. For example, the pulse of the clock signal ECK2 may be a signal shifted by half a cycle (that is, one horizontal period 1H) based on the pulse of the clock signal ECK1.

A first emission stop signal ELM1 of a turn-off level (high level) supplied to the first input terminal 101 is set to overlap at least once with a pulse of a turn-on level (low level) of the clock signal ECK1 supplied to the second input terminal 102. To this end, the first emission stop signal ELM1 may be supplied during a width wider than that of the clock signal ECK1, for example, four horizontal periods 4H. In addition, a pulse of a turn-off level (high level) of a first emission signal E1 supplied to the first input terminal 101 of the second first emission stage EST12 may also overlap at least once with a pulse of a turn-on level (low level) of the clock signal ECK2 supplied to the second input terminal 102 of the first emission stage EST12.

First, at a time point t1b, a clock signal ECK1 of a low level is supplied to the second input terminal 102. That is, a pulse may be generated in the clock signal ECK1. Accordingly, the transistor Q7 and the transistor Q9 may be turned on.

When the transistor Q7 is turned on, the first input terminal 101 and the node NE4 may be electrically connected. Here, because the transistor Q2 maintains a turn-on state, the first input terminal 101 may be electrically connected to the node NE2 via the node NE4. During a time point t1b, a pulse of a high level may not be supplied to the first input terminal 101, and thus a voltage VNE4 of the node NE4 and a voltage VNE2 of the node NE2 may be set to a low level.

When a voltage of a low level is supplied to the node NE2 and the node NE4, the transistor Q8, the transistor Q11, and the transistor Q12 may be turned on.

When the transistor Q12 is turned on, the voltage of the power line VDDL may be supplied, and thus a voltage VNE1 of the node NE1 may be set to a high level. Accordingly, the transistor Q10 may be turned off.

When the transistor Q11 is turned on, the voltage of the power line VSSL may be supplied to the output terminal 104. Therefore, the light emitting signal E1 of the turn-on level low level may be supplied to the emission line EM1 at the time point t1b.

When the transistor Q8 is turned on, the clock signal ECK1 is supplied to the node NE3. Here, because the transistor Q1 maintains a turn-on state, the clock signal ECK1 may be supplied to the node NE5 via the node NE3.

Meanwhile, when the transistor Q9 is turned on, the voltage of the power line VSSL is supplied to the node NE3 and the node NE5. Here, the clock signal ECK1 may be at a low level, and thus voltages VNE3 and VNE5 of the node NE3 and the node NE5 may be set to a low level. Accordingly, the transistor Q3 and the transistor Q6 are turned on.

When the transistor Q6 is turned on, a clock signal ECK2 of a high level is supplied from the third input terminal 103 to the second electrode of the capacitor CE2. At this time, because the transistor Q5 is in a turn-off state, the node NE1 may maintain the voltage of the power line VDDL regardless of a voltage of the node NE5 and the second electrode of the capacitor CE2.

When the transistor Q3 is turned on, the voltage of the power line VDDL may be supplied to the transistor Q4. At this time, the transistor Q4 is in a turn-off state, and thus the node NE4 may maintain a low level.

At a time t2b, a clock signal ECK1 of a high level is supplied to the second input terminal 102. That is, the pulse may be extinguished in the clock signal ECK1. Accordingly, the transistor Q7 and the transistor Q9 may be turned off. At this time, the node NE2 and the node NE1 may maintain the previous voltage by the capacitor CE1 and the capacitor CE3, and the transistor Q8, the transistor Q11, and the transistor Q12 maintain a turn-on state.

When the transistor Q8 is turned on, a clock signal ECK1 of a high level is supplied from the second input terminal 102 to the node NE3 and the node NE5. Accordingly, the transistor Q3 and the transistor Q6 are set to a turn-off state.

At a time point t3b, a clock signal ECK2 of a low level is supplied to the third input terminal 103. That is, a pulse is generated in the clock signal ECK2. Accordingly, the transistor Q4 and the transistor Q5 are turned on.

When the transistor Q5 is turned on, the second terminal of the capacitor CE2 and the node NE1 are electrically connected. At this time, because the transistor Q12 is in a turn-on state, the node NE1 maintains the voltage of the power line VDDL.

When the transistor Q4 is turned on, the second electrode of the transistor Q3 and the node NE2 are electrically connected. At this time, because the transistor Q3 is in a turn-off state, the voltage of the power line VDDL is not supplied to the node NE4 and the node NE2.

When a clock signal ECK2 of a low level is supplied to the third input terminal 103, the node NE2 is decreased to a voltage lower than the voltage of the power line VSSL by coupling of the capacitor CE1. Accordingly, a voltage of the gate electrode of the transistor Q11 and the transistor Q12 may become lower than the voltage of the power line VSSL, and thus a driving characteristic of transistors may be relatively improved.

The node NE4 may maintain a voltage of the power line VSSL approximately regardless of a voltage drop of the node NE2 by the transistor Q2. That is, because the voltage of the power line VSSL is continuously applied to the gate electrode of the transistor Q2, the voltage of the node NE4 corresponding to a source electrode of the transistor Q2 is not decreased to a value equal to or less than a value obtained by adding a threshold voltage value to the voltage of the power line VSSL. Therefore, a voltage difference between the first electrode and the second electrode of the transistor Q7 may be minimized, and thus changes to a characteristic of the transistor Q7 may be prevented or reduced.

At a time point t4b, a first emission stop signal ELM1 of a turn-off level (high level) is supplied to the first input terminal 101, and a clock signal ECK1 of a low level is supplied to the second input terminal 102. That is, a pulse is generated in the clock signal ECK1. Accordingly, the transistor Q7 and the transistor Q9 are turned on.

When the transistor Q7 is turned on, the first input terminal 101 and the node NE4 and the node NE2 are electrically connected. Therefore, the node NE4 and the node NE2 are charged with a voltage of high level, and the transistor Q8, the transistor Q11, and the transistor Q12 are turned off.

When the transistor Q9 is turned on, the voltage of the power line VSSL is supplied to the node NE3 and the node NE5, and the transistor Q3 and the transistor Q6 are turned on. At this time, even though the transistor Q3 is turned on, the voltage of the node NE4 is maintained because the transistor Q4 is in a turn-off state.

When the transistor Q6 is turned on, the second terminal of the capacitor CE2 and the third input terminal 103 are electrically connected. At this time, because the transistor Q5 is in a turn-off state, the node NE1 maintains a high level.

At a time t5b, a clock signal ECK2 of a low level is supplied to the third input terminal 103. That is, a pulse is generated in the clock signal ECK2. Accordingly, the transistor Q4 and the transistor Q5 are turned on. At this time, because the node NE3 and the node NE5 are charged with the voltage of the power line VSSL, the transistor Q3 and the transistor Q6 are in a turn-on state.

A clock signal ECK2 of a low level is applied to the node NE1 via the turned-on transistors Q5 and Q6, and the transistor Q10 is turned on. When the transistor Q10 is turned on, the voltage of the power line VDDL is supplied to the output terminal 104 as the emission signal E1. Therefore, emission signal E1 of a turn-off level (high level) may be supplied to the emission line EM1.

When the transistor Q3 and the transistor Q4 are turned on, the voltage of the power line VDDL is supplied to the node NE4 and the node NE2. Accordingly, the transistors Q8 and Q11 may stably maintain a turn-off state.

Meanwhile, when a clock signal ECK2 of a low level is supplied to the second electrode of the capacitor CE2, the voltage of the node NE5 is decreased to a voltage lower than the power line VSSL due to coupling of the capacitor CE2. Accordingly, a voltage applied to the gate electrode of the transistor Q6 is decreased to a voltage lower than the power line VSSL, and a driving characteristic of the transistor Q6 may be relatively improved.

The voltage of the node NE3 may maintain the voltage of the power line VSSL approximately regardless of the voltage of the node NE5 by the transistor Q1. That is, because the voltage of the power line VSSL is continuously applied to the gate electrode of the transistor Q1, the voltage of the node NE3 corresponding to a source electrode of the transistor Q1 is not decreased to a value equal to or less than a value obtained by adding a threshold voltage value to the voltage of the power line VSSL. Therefore, the node NE3 may maintain the voltage of the power line VSSL approximately regardless of the voltage drop of the node NE5. In this case, a voltage difference between a source electrode and a drain electrode of transistor Q8 may be minimized, and thus changes to a characteristic of the transistor Q8 may be prevented or reduced.

At a time t6b, a clock signal ECK1 of a low level is supplied to the second input terminal 102. That is, a pulse may be generated in the clock signal ECK1. Accordingly, the transistor Q7 and the transistor Q9 are turned on.

When the transistor Q7 is turned on, the node NE4 and the node NE2 are electrically connected to the first input terminal 101, and thus a voltage of a low level from the first input terminal 101 is supplied to the node NE4 and the node NE2. Accordingly, the transistor Q8, the transistor Q11, and the transistor Q12 are turned on.

When the transistor Q8 is turned on, a clock signal ECK1 of a low level is supplied to the node NE3 and the node NE5.

When the transistor Q12 is turned on, the voltage of the power line VDDL is supplied to the node NE1, and the transistor Q10 is turned off.

When the transistor Q11 is turned on, the voltage of the power line VSSL is supplied to the output terminal 104. Therefore, an emission signal E1 of a turn-on level (low level) may be supplied to the emission line EM1.

Meanwhile, the second first emission stage EST12 receiving the emission signal E1 of a turn-off level from the output terminal 104 of the first first emission stage EST11 also supplies an emission signal E2 of a turn-off level to the emission line EM2 while repeating the above-described process. That is, the first emission stages EST11 to EST14 according to some embodiments of the present disclosure may supply emission signals to the emission lines EM1 to EM4 while repeating the above-described process.

In FIGS. 9 to 11, the first emission stages EST11 to EST14 of the first emission driver 151a are described as an example, but second emission stages of the second emission driver 152a may also be configured in the same method. Therefore, an overlapping description is omitted.

FIGS. 12 to 16 are drawings illustrating aspects of some configurations of the first emission driver and the second emission driver.

Referring to FIG. 12, the first emission driver 151a1 may include first emission stages EST11, EST12, EST13, EST14, . . . , and the second emission driver 152a1 may include second emission stages EST21, EST22, EST23, EST24, . . . .

The number of the first emission stages EST11, EST12, EST13, EST14, . . . and the number of the second emission stages EST21, EST22, EST23, EST24, . . . may be the same. At this time, the number of the horizontal emission lines may be the same as the number of the first emission stages EST11, EST12, EST13, EST14, . . . .

For example, one end of each of the horizontal emission lines may be connected to a corresponding one of the first emission stages EST11, EST12, EST13, EST14, . . . and another end of each of the horizontal emission lines may be connected to a corresponding one of the second emission stages EST21, EST22, EST23, EST24, . . . .

According to some embodiments, because emission signals are supplied from both ends of the horizontal emission lines, a voltage drop phenomenon of each of the horizontal emission lines may be prevented or reduced.

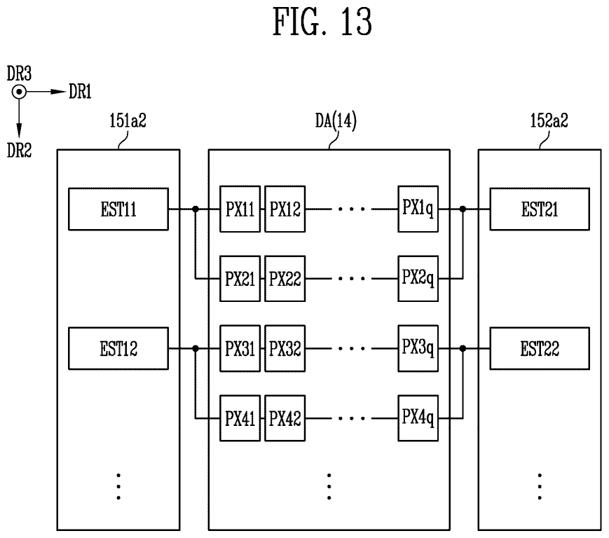

Referring to FIG. 13, the first emission driver 151a2 may include first emission stages EST11, EST12, . . . , and the second emission driver 152a2 may include second emission stages EST21, EST22, . . . .

The number of the first emission stages EST11, EST12, . . . and the number of the second emission stages EST21, EST22, . . . may be the same. At this time, the number of the horizontal emission lines may be greater than the number of the first emission stages EST11, EST12, . . . .

For example, one end of the horizontal emission lines may be connected to a corresponding one of the first emission stages EST11, EST12, . . . , and another end of the horizontal emission lines may be connected to a corresponding one of the second emission stages EST21, EST22, . . . , in a unit of two horizontal emission lines.

According to some embodiments, the area of each of the first emission driver 151a2 and the second emission driver 152a2 may be reduced.

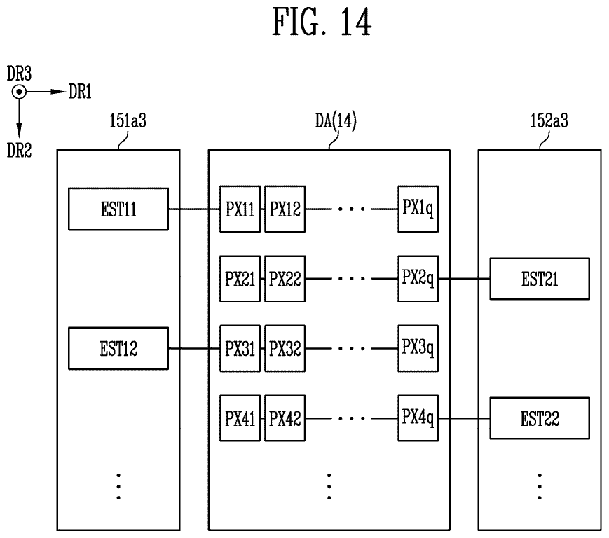

Referring to FIG. 14, the first emission driver 151a3 may include first emission stages EST11, EST12, . . . , and the second emission driver 152a3 may include the second emission stages EST21, EST22, . . . .

At this time, the horizontal emission lines may be alternately connected to one of the first emission stages EST11, EST12, . . . or one of the second emission stages EST21, EST22, . . . along the second direction DR2. For example, odd-numbered horizontal emission lines may be connected to the first emission stages EST11, EST12, . . . , and even-numbered horizontal emission lines may be connected to the second emission stages EST21, EST22, . . . . Conversely, the even-numbered horizontal emission lines may be connected to the first emission stages EST11, EST12, . . . , and the odd-numbered horizontal emission lines may be connected to the second emission stages EST21, EST22, . . . .

According to some embodiments, the area of each of the first emission driver 151a3 and the second emission driver 152a3 may be reduced.

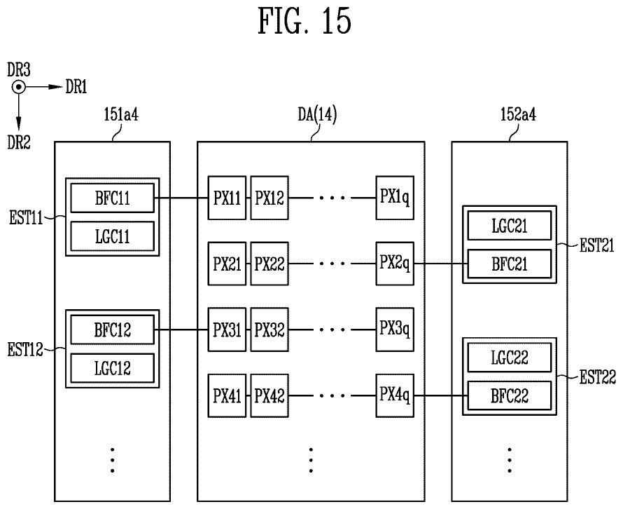

Referring to FIG. 15, the first emission driver 151a4 may include first emission stages EST11, EST12, . . . , and the second emission driver 152a4 may include second emission stages EST21, EST22, . . . .

The horizontal emission lines may be alternately connected to one of the first emission stages EST11, EST12, . . . or one of the second emission stages EST21, EST22, . . . along the second direction DR2. For example, odd-numbered horizontal emission lines may be connected to one of the first emission stages EST11, EST12, . . . , and even-numbered horizontal emission lines may be connected to the second emission stages EST21, EST22, . . . . Conversely, the even-numbered horizontal emission lines may be connected to the first emission stages EST11, EST12, . . . , and the odd-numbered horizontal emission lines may be connected to the second emission stages EST21, EST22, . . . .

At this time, the respective first emission stages EST11, EST12, . . . may include first logic circuits LGC11, LGC12, . . . and first buffer circuits BFC11, BFC12, . . . The first buffer circuit BFC11, BFC12, . . . may be positioned in the direction opposite to the second direction DR2 from the first logic circuit LGC11, LGC12, . . . and may be connected to a corresponding horizontal emission line.

In addition, the respective second emission stages EST21, EST22, . . . may include second logic circuits LGC21, LGC22, . . . and second buffer circuits BFC21, BFC22, . . . . The second buffer circuit BFC21, BFC22, . . . may be positioned in the second direction DR2 from the second logic circuit LGC21, LGC22, . . . and may be connected to a corresponding horizontal emission line.

According to some embodiments, the area of each of the first emission driver 151a4 and the second emission driver 152a4 may be additionally reduced. In addition, by arranging the buffer circuit adjacent to the horizontal emission line which is a connection object, a line design may be simplified.

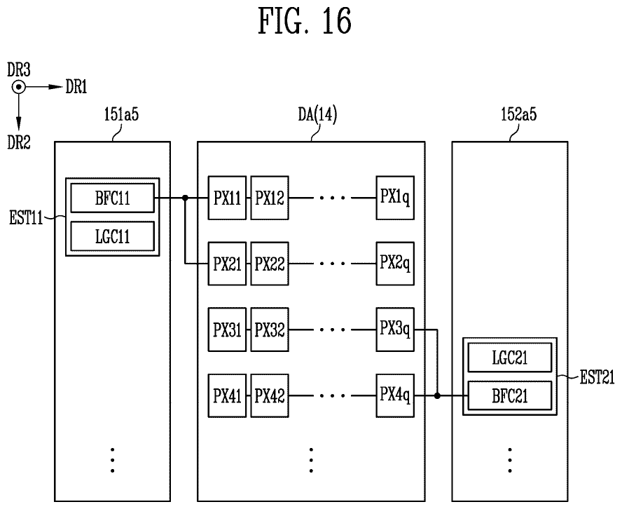

Referring to FIG. 16, the first emission driver 151a5 may include first emission stages EST11, . . . , and the second emission driver 152a5 may include second emission stages EST21, . . . .

The horizontal emission lines may be alternately connected to one of the first emission stages EST11, . . . or one of the second emission stages EST21, . . . along the second direction DR2 in a unit of two horizontal emission lines.

At this time, the respective first emission stages EST11, . . . may include first logic circuits LGC11, . . . and first buffer circuits BFC11, . . . . The first buffer circuits BFC11, . . . may be positioned in the direction opposite to the second direction DR2 from the first logic circuits LGC11, . . . and may be connected to two corresponding horizontal emission lines.

The respective second emission stages EST21, . . . may include second logic circuits LGC21, . . . and second buffer circuits BFC21, . . . . The second buffer circuits BFC21, . . . may be positioned in the second direction DR2 from the second logic circuits LGC21, . . . and may be connected to two corresponding horizontal emission lines.

According to some embodiments, compared to the embodiments of FIG. 15, the area of each of the first emission driver 151a5 and the second emission driver 152a5 may be additionally reduced.

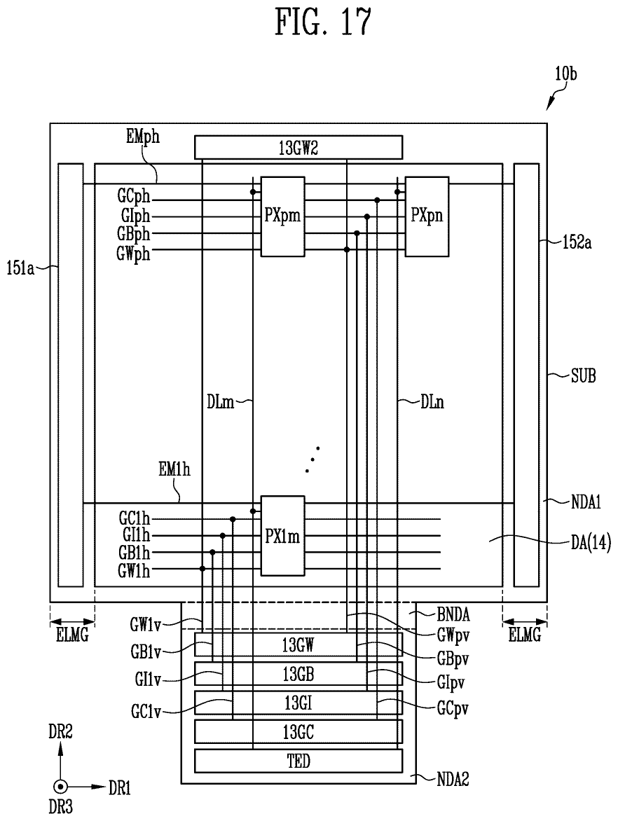

FIGS. 17 to 19 are drawings illustrating a display device according to some embodiments of the present disclosure.

The display device 10b of FIG. 17 may further include an additional scan driver 13GW2 positioned in the first non-display area NDA1 compared to the display device 10a of FIG. 8.

The additional scan driver 13GW2 may be connected to the first vertical scan lines GW1v, . . . , and GWpv. For example, the additional scan driver 13GW2 may have the same structure as the first scan driver 13GW. According to some embodiments, a narrow bezel may be implemented by using the margin of the first non-display area NDA1, and as the emission signals may be supplied from at both ends of the first vertical scan lines GW1v, . . . , and GWpv, a voltage drop phenomenon of each of the first vertical scan lines GW1v, . . . , and GWpv may be prevented or reduced.

A relationship between the first scan driver 13GW and the additional scan driver 13GW2 may be the same (or substantially the same) as one of the relationships between the first emission driver and the second emission driver described with reference to FIGS. 12 to 16. At this time, an effect according to each embodiment may be applied.

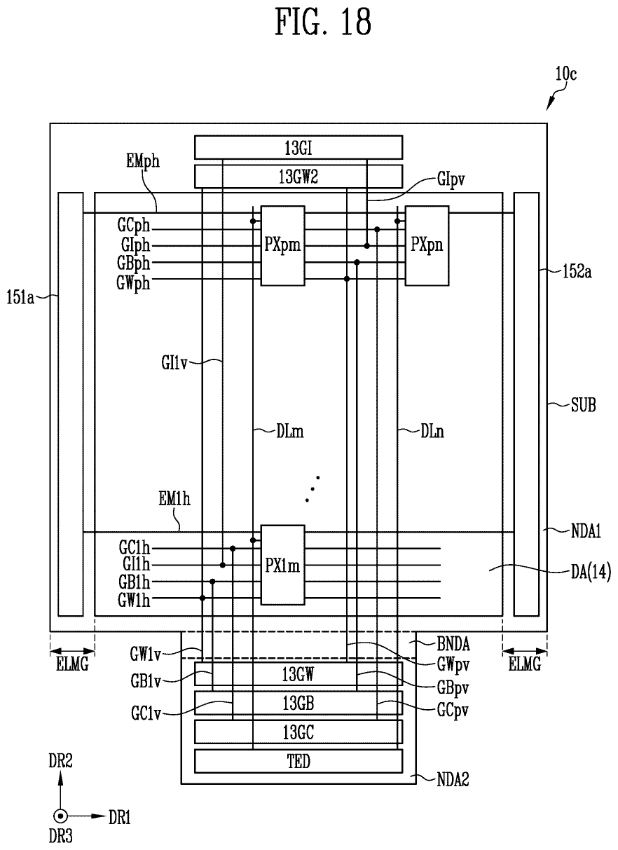

The display device 10c of FIG. 18 is different from the display device 10b of FIG. 17, in that the third scan driver 13GI is positioned in the first non-display area NDA1. According to some embodiments, a width of the second non-display area NDA2 may be relatively reduced.

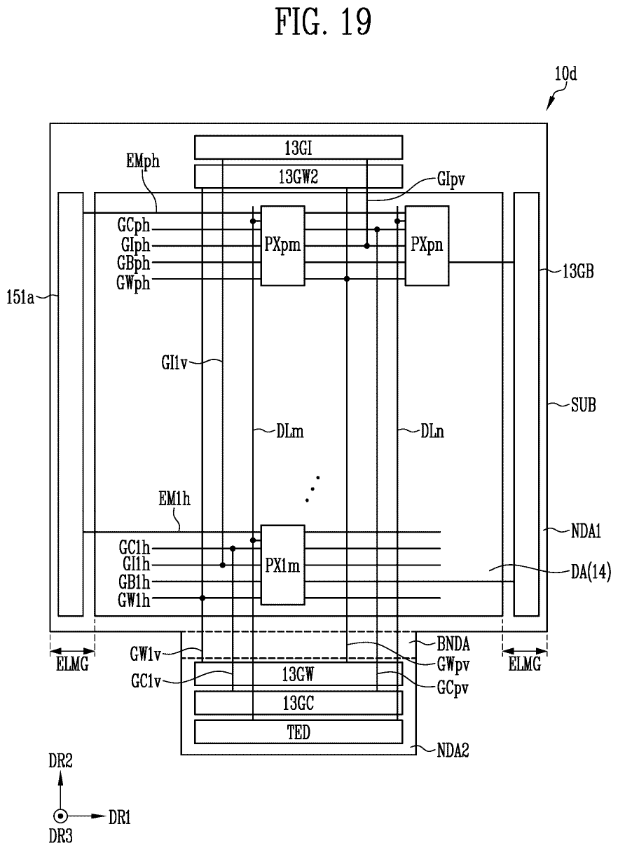

The display device 10d of FIG. 19 is different from the display device 10c of FIG. 18, in that the second scan driver 13GB is positioned at a position of the second emission driver 152a. The second scan driver 13GB may be directly connected to the second horizontal scan lines. According to some embodiments, the first scan driver 13GW, the third scan driver 13GI, or the fourth scan driver 13GC may be positioned at the position of the second emission driver 152a.

According to some embodiments, a diagonal effect may be reduced.

A display device according to an embodiment is applicable to various types of electronic devices. In an embodiment, an electronic device includes the above-described display device and may further include other modules or devices having additional functions in addition to the display device.

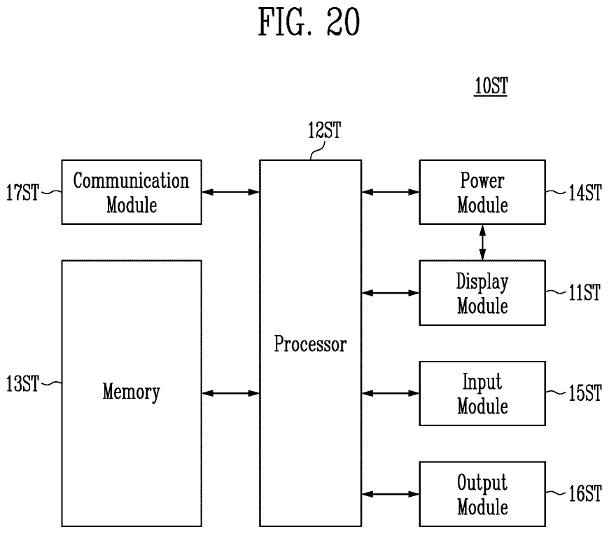

FIG. 20 is a block diagram of an electronic device according to an embodiment. Referring to FIG. 20, the electronic device 10ST may include a display module 11ST, a processor 12ST, a memory 13ST, and a power module 14ST.

The processor 12ST may include at least one of a central processing unit (CPU), an application processor (AP), a graphic processing unit (GPU), a communication processor (CP), an image signal processor (ISP), and a controller. In an embodiment, the processor 12ST may be divided into two or more parts from a functional or structural perspective. For example, the processor 12ST includes a main processor in the form of a first driving chip including a CPU and an auxiliary processor in the form of a second driving chip. The auxiliary processor may include a controller that receives image data signals from the main processor and processes the image data signals to conform to interface specifications of the display module 11ST. The processor 12ST may provide input image data. The display module 11ST may display an image based on the input image data.

The memory 13ST may include at least one of a non-volatile memory and a volatile memory. The memory 13ST may store data and/or information used to operate the processor 12ST or the display module 11ST. When the processor 12ST executes an application stored in the memory 13ST, image data signals and/or input control signals may be transferred to the display module 11ST. The display module 11ST may process the provided signals and output image information on a display screen.

The power module 14ST may include a power supply module, such as a power adapter or a battery device, and a power conversion module. The power conversion module converts power supplied by the power supply module and generates power to operate the electronic device 10ST. Power conversion performed by the power conversion module may include DC-DC conversion, AC-AC conversion, and DC-AC conversion, but embodiments are not limited thereto.

The electronic device 10ST may further include an input module 15ST, a non-image output module 16ST, and/or a communication module 17ST.

The input module 15ST may provide input information to the processor 12ST and/or the display module 11ST. The input module 15ST may include not only a physical button, a keyboard, and a microphone, but also various kinds of sensor modules. Examples of the sensor modules may include a biometric sensor, such as a blood pressure sensor, a blood glucose sensor, an electrocardiogram sensor, and a heart rate sensor, as well as a touch sensor, a pressure sensor, a distance sensor, a position sensor, a digitizer, a motion recognition sensor, a camera sensor (an image sensor), a light receiving sensor, a photoelectric conversion sensor, and a temperature sensor.

The non-image output module 16ST may receive information other than image information from the processor 12ST and provide the information to a user. Examples of the non-image output module 16ST may include an audio module, a haptic module, a light emitting module, and unique functional modules of the electronic device such as a cooling module of a refrigerator.

The communication module 17ST may serve to facilitate information exchange between the electronic device 10ST and an external device, and may include a transmitter and a receiver. The communication module 17ST may include various types of wireless communication modules such as a mobile communication module, a WiFi module, and a Bluetooth module, or various kinds of wired communication modules.

At least one of the above-described components of the electronic device 10ST may be included in the display device according to embodiments as described above. In addition, in terms of functionality, some of the individual modules included in one module may be included in a display device and others may be provided separately from the display device. For example, the display module 11ST is included in the display device, whereas the processor 12ST, the memory 13ST, and the power module 14ST are not included in the display device and are instead provided separately in the electronic device 10ST. In another example, the display device further includes the power module 14ST and the power module 14ST supplies power to the processor 12ST and the memory 13ST that are provided separately from the display device in the electronic device 10ST. However, embodiments are not limited to this example.

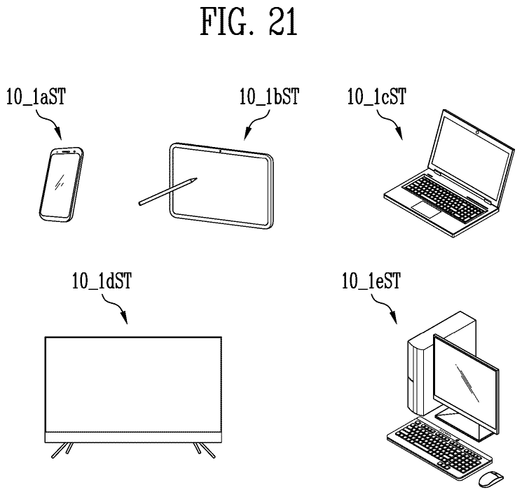

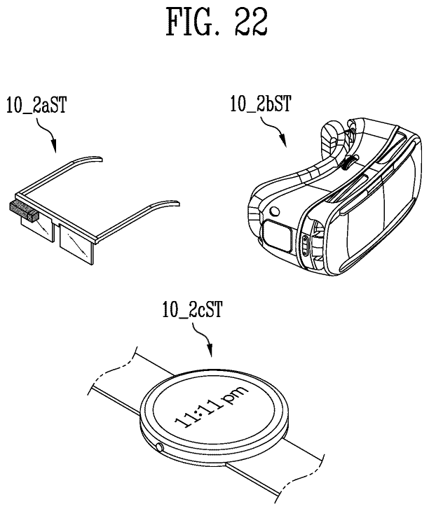

FIGS. 21 to 23 shows schematic views of various embodiments of an electronic device. FIGS. 21 to 23 illustrate examples of various types of electronic devices to which embodiments of a display device are applied.

FIG. 21 shows a smartphone 10_1aST, a tablet PC 10_1bST, a laptop computer 10_1cST, a television (TV) 10_1dST, and a desktop monitor 10_1eST as examples of the electronic device 10ST.

The smartphone 10_1aST may include an input module, such as a touch sensor, and a communication module in addition to the display module 11ST. The smartphone 10_1aST may process information received through the communication module or the input module and display the processed information on the display module of the display device.

Similarly to the smartphone 10_1aST, the tablet PC 10_1bST, the laptop computer 10_1cST, the television (TV) 10_1dST, and the desktop monitor 10_1eST may each include a display module and an input module and further include a communication module in some embodiments.

FIG. 22 shows examples in which the electronic device 10ST including the display module 11ST is applied to a wearable electronic device. The examples of the wearable electronic device may include smart glasses 10_2aST, a head-mounted display (HMD) 10_2bST, and a smart watch 10_2cST.

The smart glasses 10_2aST and the head-mounted display 10_2bST may each include a display module that projects a display image and a reflector that reflects the projected display image to direct it to the user's eyes, thereby providing the user with a virtual reality or augmented reality screen.

The smart watch 10_2cST may include a biometric sensor as an input device and provide biometric information detected by the biometric sensor to the user through a display module.

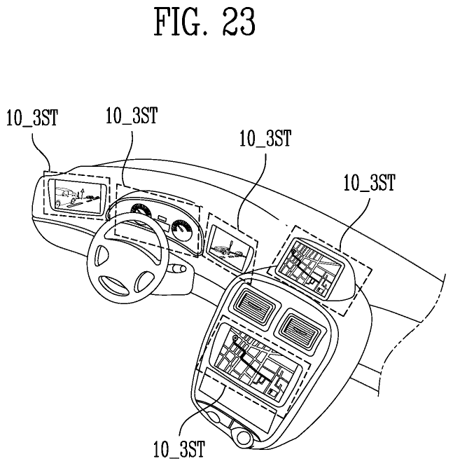

FIG. 23 shows an example in which the electronic device 10ST including the display module 11ST is applied to various kinds of an automotive electronic device 10_3ST. For example, the automotive electronic device 10_3ST is applied to a center information display (CID), which may be employed in the instrument cluster or the center fascia of the vehicle or disposed at the dashboard of the vehicle. The automotive electronic device 10_3ST may also be applied to a room mirror display replacing side mirrors.

Though not shown in FIG. 23, examples of electronic devices to which embodiments of a display device are applied may include various home appliances which display information on display modules, such as refrigerators, washing machines, dryers, air conditioners, and robot vacuum cleaners, as well as devices aimed at displaying screens, such as billboards, electronic display boards, and game consoles. In addition, when a display module has a function of transmitting light, the display module may be applied to an electronic device such as a smart window or a transparent display device which displays a background and a display image together. However, the types of an electronic device according to an embodiment are not limited to the above-described examples, and other various types of electronic devices are applicable.

The drawings referred to so far and the detailed description of the disclosure described herein are merely examples of the disclosure, are used for merely describing the disclosure, and are not intended to limit the meaning and the scope of embodiments according to the present disclosure as defined in the appended claims, and their equivalents. Therefore, those skilled in the art will understand that various modifications and equivalent other embodiments are possible from these. Thus, the true scope of the disclosure should be determined by the appended claims, and their equivalents.

What is claimed is:

1. A display device comprising:
a substrate including a display area and a non-display area surrounding the display area;
pixels in the display area and connected to first horizontal scan lines extending in a first direction and horizontal emission lines extending in the first direction;
a first scan driver on one side of the non-display area; and
a first emission driver on another side of the non-display area,
wherein the first scan driver is connected to first vertical scan lines extending in a second direction different from the first direction,
the first vertical scan lines contact the first horizontal scan lines in the display area, and
the first emission driver is directly connected to the horizontal emission lines.

2. The display device according to claim 1, wherein the substrate further includes a bending area between one side of the non-display area and the display area.

3. The display device according to claim 1, wherein the first emission driver is positioned in a direction opposite to the first direction from the display area, and
the first scan driver is positioned in a direction opposite to the second direction from the display area.

4. The display device according to claim 1, further comprising:
a second emission driver positioned in the first direction from the display area,
wherein the second emission driver is connected to at least a portion of the horizontal emission lines.

5. The display device according to claim 4, wherein the first emission driver includes first emission stages,
the second emission driver includes second emission stages, and
a number of the first emission stages and a number of the second emission stages are equal.

6. The display device according to claim 5, wherein a number of the horizontal emission lines is equal to a number of the first emission stages,
one end of each of the horizontal emission lines is connected to a corresponding one of the first emission stages, and another end of each of the horizontal emission lines is connected to a corresponding one of the second emission stages.

7. The display device according to claim 5, wherein a number of the horizontal emission lines is greater than a number of the first emission stages,
one end of the horizontal emission lines is connected to a corresponding one of the first emission stages in a unit of two horizontal emission lines, and another end of the horizontal emission lines is connected to a corresponding one of the second emission stages in a unit of two horizontal emission lines.

8. The display device according to claim 5, wherein the horizontal emission lines are alternately connected to one of the first emission stages or one of the second emission stages along the second direction.

9. The display device according to claim 8, wherein each of the first emission stages includes a first logic circuit and a first buffer circuit,
each of the second emission stages includes a second logic circuit and a second buffer circuit,
the first buffer circuit is positioned in a direction opposite to the second direction from the first logic circuit and is connected to a corresponding horizontal emission line, and
the second buffer circuit is positioned in the second direction from the second logic circuit and is connected to a corresponding horizontal emission line.

10. The display device according to claim 5, wherein the horizontal emission lines are alternately connected to one of the first emission stages or one of the second emission stages along the second direction in a unit of two horizontal emission lines.

11. The display device according to claim 10, wherein each of the first emission stages includes a first logic circuit and a first buffer circuit,
each of the second emission stages includes a second logic circuit and a second buffer circuit,
the first buffer circuit is positioned in a direction opposite to the second direction from the first logic circuit and is connected to two corresponding horizontal emission lines, and
the second buffer circuit is positioned in the second direction from the second logic circuit and is connected to two corresponding horizontal emission lines.

12. The display device according to claim 1, further comprising:
an additional scan driver in the non-display area,
wherein the additional scan driver is connected to the first vertical scan lines.

13. The display device according to claim 12, further comprising:
a second scan driver in the non-display area,
wherein the pixels are further connected to second horizontal scan lines extending in the first direction,
the second scan driver is connected to second vertical scan lines extending in the second direction, and
the second vertical scan lines contact the second horizontal scan lines in the display area.

14. The display device according to claim 13, further comprising:
a third scan driver in the non-display area,
wherein the pixels are further connected to third horizontal scan lines extending in the first direction,
the third scan driver is connected to third vertical scan lines extending in the second direction, and
the third vertical scan lines contact the third horizontal scan lines in the display area.

15. The display device according to claim 1, further comprising:
a second scan driver positioned in the first direction from the display area,
the pixels are further connected to second horizontal scan lines extending in the first direction, and
the second scan driver is directly connected to the second horizontal scan lines.

16. A display device comprising:
a substrate including a display area, a first non-display area surrounding the display area, a bending area connected to the first non-display area, and a second non-display area connected to the bending area;
pixels in the display area and connected to first horizontal scan lines extending in a first direction and horizontal emission lines extending in the first direction;
a first scan driver in the second non-display area; and
a first emission driver in the first non-display area,
wherein the first scan driver is connected to first vertical scan lines extending in a second direction different from the first direction,
the first vertical scan lines contact the first horizontal scan lines in the display area, and
the first emission driver is directly connected to the horizontal emission lines.

17. The display device according to claim 16, wherein the first vertical scan lines sequentially cross the second non-display area, the bending area, the first non-display area, and the display area.

18. The display device according to claim 16, wherein the first emission driver is positioned in a direction opposite to the first direction from the display area, and
the first scan driver is positioned in a direction opposite to the second direction from the display area.

19. The display device according to claim 16, further comprising:
a second emission driver positioned in the first direction from the display area,
wherein the second emission driver is connected to at least a portion of the horizontal emission lines.

20. An electronic device comprising:
a processor to provide input image data; and
a display device to display an image based on the input image data, the display device comprising:
a substrate including a display area and a non-display area surrounding the display area;
pixels in the display area and connected to first horizontal scan lines extending in a first direction and horizontal emission lines extending in the first direction;
a first scan driver on one side of the non-display area; and
a first emission driver on another side of the non-display area,
wherein the first scan driver is connected to first vertical scan lines extending in a second direction different from the first direction,
the first vertical scan lines contact the first horizontal scan lines in the display area, and
the first emission driver is directly connected to the horizontal emission lines.
